(19) United States
(12) Patent Application Publication
(10) Pub. No.: US 2003/0038022 A1
(43) Pub. Date: Feb. 27, 2003

(54) Solar desalination plant

(76) Inventor: Mary Rogde, Kaneohe, HI (US)

Correspondence Address: MARY ROGDE, 46-285 IKIIKI ST., KANEOHE, HI, 96744, US

(21) Appl. No.: 09/935,562

(22) Filed: Aug. 21, 2001

(51) Int. Cl. B01D 3/02; C02F 1/14

(52) U.S. Cl. 202/234; 159/904; 159/DIG. 15; 159/DIG. 16; 202/205; 202/267.1; 203/10; 203/11; 203/86; 203/91; 203/100; 203/DIG. 1; 203/DIG. 17

(57) ABSTRACT

The present invention, a SOLAR DESALINATION PLANT is a water desalinating plant utilizing solar energy. It comprises of an airtight housing chamber covered with a transparent dome at its top and a transparent wall constructed over a source of saline or murky water. The chamber stands in the water and the water covers entire bottom portion inside the chamber. The surface of the water inside the chamber is covered with black floats. There is an horizontal channel in the form of an open duct above the surface of the water all around fixed to the wall inside the chamber. The channel slightly slopes down into an outlet pipe and a transparent U-tube connecting to a transparent collecting tank. A suction pump is connected between the collecting tank and a storage tank through a valve. The storage tank is also connected to the collecting tank through another valve. The transparent dome allows the sun's rays to pass through into the chamber to heat the black floats. The water that is in contact with the black floats gets evaporated due to the latent heat supplied by the floats. The water vapour thus produced in the chamber, rises up and gets condensed on the cooler parts of the dome in the form of droplets. The droplets as they collect, slide down the wall into the channel and pass into the U-tube and then into the collecting tank. When sufficient water is collected in the collecting tank, the suction pump is activated to pump the water into the storage tank. As the suction pump operates, low pressure is also created in the chamber and the low pressure enhances the evaporation of water in the chamber. In absence of the suction pump, the water from the collecting tank can also be drawn by gravity into the storage tank which is at lower level. The solar rays, not only produce evaporation but also disinfect the water vapour to obtain pure distilled water. Since the solar energy is abundantly available freely in nature, the SOLAR DESALINATION PLANT exposes its uniqueness in presenting a low cost set up and economical production of fresh water in large scale.

### BACKGROUND OF THE INVENTION

It has long been known that pure water can be produced from impure or saline water by many processes such as distillation, freezing etc. In many of the processes large amount of energy is spent and complicated equipment utilized, making them very expensive in operation and maintenance. Therefore, it is desired to develop a method utilizing solar energy, as it is freely and abundantly available in nature. In these respects, the SOLAR DESALINATION PLANT according to the present invention, substantially departs from the conventional concepts and designs of prior art and so doing provides an apparatus primarily developed for the purpose of producing purified water, with such apparatus being simple in construction and very much less in operational and maintenance costs. The plant is environment friendly since it does not produce any pollutants.

### OBJECTS OF THE INVENTION

It is therefore, an object of the present invention to provide a new SOLAR DESALINATION PLANT for producing pure water out of saline or impure water by utilizing solar energy.

It is another object of the present invention to provide a SOLAR DESALINATION PLANT and a method which has many advantages of desalination and purification of water mentioned heretofore and many novel functions that result in the new SOLAR DESALINATION PLANT which is not anticipated, rendered obvious, suggested or even implied by any of the prior art desalination plants either alone or in any combination thereof.

It is yet another object of the present invention to provide a new SOLOAR DESALINATION PLANT which is to be simple in construction and efficient in functioning.

It is a further object of the present invention to provide a new SOLAR DESALINATION PLANT that will be durable and reliable in construction and working.

An even further object of the present invention is to provide a new SOLAR DESALINATION PLANT that is susceptible of low cost of manufacture with regard to both materials and labor, and which accordingly is then susceptible of low price of the derivation to the consuming public, truly making such SOLAR DESALINATION PLANT economically available to the buying public.

Still yet another object of the present invention is to have a new SOLAR DESALINATION PLANT that could provide in the apparatus and methods of the prior art of some of the advantages thereof, which simultaneously overcoming disadvantages of expending energy, normally associated therewith.

Still another object of the present invention is to provide a new SOLAR DESALINATION PLANT with a purpose of making it environmental friendly by avoiding combustion of any fuels that produce pollutants.

The abstract together with the objects of the invention along with various features of novelty, which characterize the invention, are pointed out with particularity in the claims annexed to and forming a part of this disclosure.

For better understanding of this invention, its operating advantages and the specific objects obtained by its use, reference should have to be made to the accompanying descriptive matter and drawing in which there is an illustrated preferred embodiment of the invention.

### BRIEF DESCRIPTION OF THE DRAWING AND EMBODIMENT:

The present invention, the SOLAR DESALINATION PLANT will be better understood and the objects even other than those set forth above will become apparent when consideration is given to the following detailed description thereof. Such description makes reference to the annexed drawing, wherein:

FIG. 1 is a schematic diagram of the present invention SOLAR DESALINATION PLANT, showing the front view in vertical cross section.

As required, detailed embodiments of the present invention are disclosed herein; however, it is to be understood that the disclosed embodiments are merely exemplary of the invention that may be embodied in various forms. Therefore, specific structural and functional details disclosed herein are not to be interpreted as limiting, but merely as a basis for the claims and as a representative basis for teaching one skilled in the art to employ variously the present invention in virtually any appropriately detailed structure.

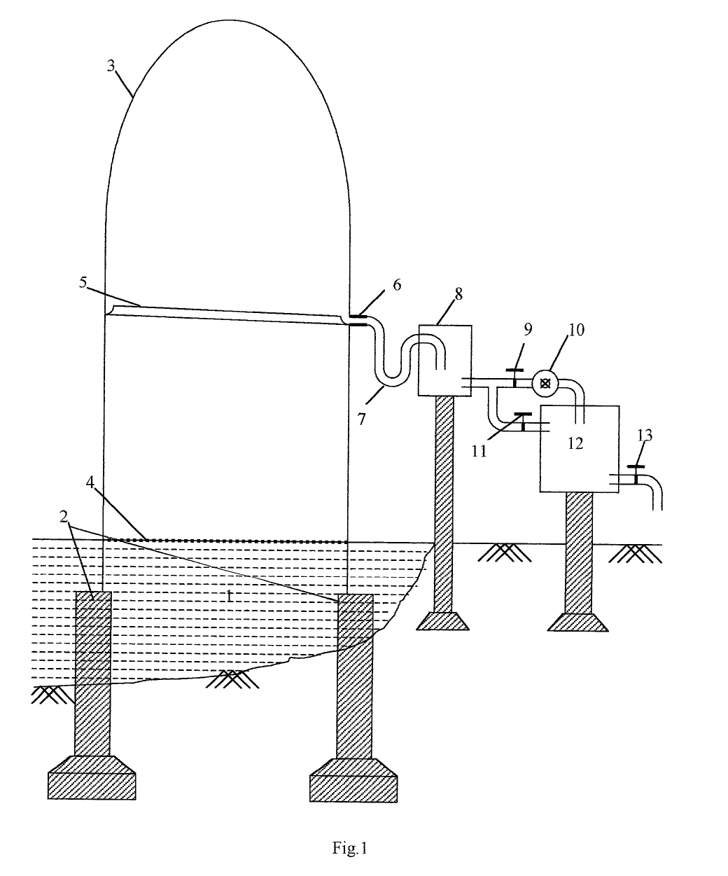

In the FIG. 1, the various parts of the plant housing are represented by reference numerals. They are:

The water source 1, foundation pillars 2, a transparent dome 3, black floats 4, an open duct channel 5, an outlet pipe 6, a U-tube 7, a collecting tank 8, a suction pump valve 9, a suction pump 10, a bypass valve 11, a storage tank 12 and outlet tap 13.

The foundation pillars 2 are erected over the water source 1 to support the structure of the transparent dome 3 that forms the closed roof and wall of the chamber housing to stand on the pillars 2. The plant chamber becomes airtight by enclosing the water at its bottom. The black floats 4 cover the whole surface of the water 1 inside the plant housing and floating over the surface of the water. The water 1 inside the chamber has free access to the water source outside the chamber through the foundation pillars 2.

The channel 5, which is in the form of an open duct, runs along the wall of the chamber horizontally and is slightly sloping down towards the outlet pipe 6. The outlet pipe 6 at its outer end is connected to the U-tube 7. The other limb of the U-tube 7 is connected to the collecting tank 8. The collecting tank 8 is also connected to the suction pump 10 through the valve 9 which can be manually operated. The suction pump 10 in turn, is connected to the storage tank 12. The bypass valve 11 is connected between the collecting tank and the storage tank, bypassing the valve 9 and the suction pump 10. The bypass valve 11 is also operated manually. The U-tube 7 and the collecting tank 8 are also made of transparent material.

### Working

When there is sunlight, the rays of the sun enter into the chamber by passing through the transparent dome 3 and fall on the black floats 4. The black floats 4 absorb the heat energy of the sun's rays. The water 1, which is in contact with the black floats 4, receives the heat and becomes vapor without boiling due to the latent heat. The water vapor thus produced, rises up and comes in contact with the top portion of the dome 3. As the roof is naturally at lower temperature than the vapor, the water vapor condenses forming water droplets on the roof inside dome. When the size of the droplets increase due to increase of evaporation and condensation, the drops of water slide down into the channel 5.

As the water collects in the channel 5, the water flows through outlet tube 6 into the U-tube 7, and then into the collecting tank 8. The limb of the U-tube 7 connected to the collecting tank 8 is slightly at lower level to that of the other limb and the end of the U-tube 7 kept inside the collecting tank 8, is little above the bottom of the U-tube. This is to have siphon effect to suck water into the collecting tank when the U-tube is full. Since the collecting tank is transparent, the level of water in it can be observed to pump out. When there is sufficient water collected inside the collecting tank 8, the water is pumped out into the storage tank 12 by the suction pump 10, during which time the valve 9 is kept opened and the valve 11 is kept closed. When the suction pump 10 is not in use or when it is not incorporated, then the valve 9 is kept closed and the valve 11 is opened, so that the water from the collecting tank 8, could flow down into the storage tank 12 by gravity as the storage tank 12 is fixed below the level of the collecting tank 8. The water that is finally collected in the storage tank can be taken out through the outlet tap 13. When the pump 10 sucks the water from the collecting tank 8, low pressure is created in the chamber, this enhances evaporation in it and so the condensed water flow increases. Since the water vapor in the chamber is also exposed to the sun's rays, the condensed water is purified further in addition to desalination. In addition to desalination, the rainwater can also be collected through an open duct fixed outside to the chamber parallel to 5.

Therefore, the foregoing is considered as illustrative only of the principles of the invention. Further, since numerous modifications and changes will readily occur to those skilled in the art, it is not desired to limit the invention to the exact construction and working shown and described, and accordingly, all suitable modifications and equivalents may be resorted to, falling within the scope of the invention.

Having illustrated and described the principles of the invention in embodiment, it should be apparent to those skilled in the art that the invention can be modified in arrangement and detail without departing from such principles described herein.

All modifications coming within the spirit and scope of the invention are as stated in the following claims:

1. A Solar Desalination Plant comprising in combination:
(a) An airtight housing called a chamber erected in water, in the form of a dome having its top, and sides made of transparent material to allow the sun's rays to pass freely into it, and
(b) the said chamber containing black floats spread over the surface of the water inside the chamber to receive the heat energy of the solar rays and
\mathring{c} the said chamber having a channel, an open duct fixed all along its wall horizontally for the condensed water drops to be collected, and
(d) the said channel being connected to an outlet pipe and the outlet pipe to a U-tube that is connected to a collecting tank which is in turn connected to a suction pump through a valve, and
(e) the said suction pump is also connected to a storage tank, and
(f) the said collecting tank is also connected to the said storage tank through another valve and the said storage tank is to be filled with the condensed water from the said chamber finally,
(g) whereby the said Solar Desalination Plant may be selectively urged to produce pure water free from dissolved impurities by utilizing the solar energy.
